(19) United States
(12) Patent Application Publication
(10) Pub. No.: US 2018/0191467 A1
(43) Pub. Date: Jul. 5, 2018

(54) METHOD FOR TRANSMITTING DATA THROUGH SYSTEM BUS BETWEEN MAIN CONTROLLER AND NODE OF ROBOT, AND DEVICE THEREOF

(71) Applicant: UBTECH Robotics Corp., Shenzhen (CN)

(72) Inventors: YOUJUN XIONG, Shenzhen (CN); Hailang Zhou, Shenzhen (CN); Musen Zhang, Shenzhen (CN)

(21) Appl. No.: 15/694,865

(22) Filed: Sep. 4, 2017

(30) Foreign Application Priority Data
Dec. 30, 2016 (CN) 201611253835.3

(51) Int. Cl. H04L 1/18; H04L 12/40; H04L 1/08; H04L 1/16

(52) U.S. Cl. CPC H04L 1/1809; H04L 12/40; H04L 2212/00; H04L 1/1642; H04L 2012/40215; H04L 1/08

(57) ABSTRACT

The present disclosure relates to a method for transmitting data through system bus between a main controller and a node of a robot. The method includes sequentially sending date frames to the node; receiving a message of an abnormal, data transmission sent by the main controller; resending the data frames being transmitted abnormally upon receiving the message. The present disclosure also provides a device for transmitting data through system bus.

### CROSS REFERENCE TO RELATED APPLICATIONS

This application claims priority to Chinese Patent Application No. 201611253835.3, filed Dec. 30, 2016, which is hereby incorporated by reference herein in its entirety.

### BACKGROUND

### 1. Technical Field

The present disclosure relates to data, transmission field, and particularly to a transmission, method for buses and the device thereof.

### 2. Description of Related Art

Controller Area Network (CAN) bus is a serial communication protocol for real-time applications. It adopts twisted pair to transmit signals, which is one of the most widely used field buses in the world.

Nowadays, robots are characterized by the attributes below: 1. motors of each the execution nodes are directed to heavy loading, large currents, and frequently on and off, strong electric magnetic interfere source; 2. a lot of execution nodes; 3. a lot of nodes have to be controlled by a high speed and synchronous manner when performing various action; 4. demand toward high reliability due to human interactions; 5. facing more complex electric-magnetic environment when operating in a more dangerous environment in the futures.

Based on above, bad environments and mission complexity lead to higher reliability toward data processing and communication system, and thus the CAN bus protocol, has to be enhanced.

### BRIEF DESCRIPTION OF THE DRAWINGS

FIG. 1 is a flowchart illustrating a data transmission method for system bus in accordance with one embodiment of the present disclosure.

FIG. 2 is a flowchart illustrating a method for transmitting data through system bus in accordance with another embodiment of the present disclosure.

FIG. 3 is a flowchart illustrating a method for transmitting data through system bus in accordance with another embodiment of the present disclosure.

FIG. 4 is a flowchart illustrating a method for transmitting data through system bus in accordance with another embodiment of the present disclosure.

FIG. 5 is a flowchart illustrating a method for transmitting data through system bus in accordance with another embodiment of the present disclosure.

FIG. 6 is a flowchart illustrating a method for transmitting data through system bus in accordance with another embodiment, of the present disclosure.

FIG. 7 is a schematic view of a device for transmitting data through system bus in accordance with one embodiment of the present disclosure.

FIG. 8 is a schematic view of a device for transmitting data through system bus in accordance with another embodiment of the present disclosure.

FIG. 9 is a schematic view of a device for transmitting data through system bus in accordance with another embodiment of the present disclosure.

FIG. 10 is a flowchart illustrating a method for transmitting data through system,bus in accordance with another embodiment of the present disclosure.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown. The figure and the embodiment described according to figure are only for illustration, and the present disclosure is not limited to these embodiments. It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

The disclosure provides a CAN2.0B bus protocol solution for communication between a main controller of a robot and a plurality of execution nodes, i.e., servos. The solution relates to modify standard data frame and extended data frame described in the CAN2.0B, such that identifiers of arbitration field and fields of segments of data field in the standard data frame and the extended data frame are configured with new functions, to make CAN2.08 bus snore suitable to robot control. The identifier field of the arbitration field in the standard data frame and the extended data frame is modified respectively as Table A-1 and Table A-2.

TABLE A-1
Modification regarding identifier fields of arbitration field of standard data
frame

Original definitions in the identifier
fields of the arbitration field

| | ID10 | ID9 | ID8 | . . . | ID0 |
|---|---|---|---|---|---|
| New definition | M1 | M0 | CH8 | . . . | CH0 |

Wherein M1 and M0 indicate, frame mode, and values of M1 and M0 may include00, 01, 10, and 11;

CH8-CH0 indicate communication channels of the nodes, which ranges from 0 to 511. When Channel=0, the data frame is a broadcast frame. All nodes may receive the broadcast frame.

TABLE A-2
Modification regarding identifier fields of arbitration field of expanded data frame

| | Original definition | | | | | | | | | | | | |
|---|---|---|---|---|---|---|---|---|---|---|---|---|---|
| | ID10 | ID9 | ID8 | ID7 | ID6 | ID5 | . . . | ID0 | EID17 | EID16 | EID15 | . . . | EID0 |
| New | M1 | M0 | EM0 | N | END | I7 | . . . | I2 | I1 | I0 | CH15 | . . . | CH0 |
| definition | | | | | | | | | | | | | |

Wherein M1 and M0 indicate the frame mode, and the values of M1 and M0 may include 00, 01, 10, and 11;

EM0 indicates the extended frame mode. The values of the EM0 include 0 and 1. The definition of the frame modes of the extended frame is shown, as Table A-11.

TABLE A-11
Definition of frame mode of expanded data frames

| M1 | M0 | EM0 | Description | Function |
|---|---|---|---|---|
| 0 | 0 | 0 | Node control | Control node to execute action |
| | | | instruction frame | |
| 0 | 1 | 0 | Node return | Return the collecting data of the sensoring node or |
| | | | instruction frame | status of the node |
| 0 | 0 | 1 | Uploading node | Use extended data frame to transmit |
| | | | serial code frame | |
| 0 | 1 | 1 | Configuring | Configure data channels for nodes |
| | | | channel frame of | |
| | | | channels | |
| 1 | 0 | 0 | Block control | Sending terminals confirms whether data have |
| | | | instruction frame | been correctly received by receiving terminals. |
| 1 | 1 | 0 | Block return | |
| | | | instruction frame | |
| 1 | 0 | 1 | Output frame of | Detecting a lost frame according to the sequence |
| | | | block data | number of the data frame, and the block control |
| 1 | 1 | 1 | Input frame of | instruction frame and the block return instruction |
| | | | block data | frame are adopted to confirm data re-transmission |

N is a reserved bit, which has not been configured temporarily.

END indicates whether the frame is the last frame in the data transmission. When END is equal: to “0”, the frame is not the last frame. When END is equal to “1”, the frame is the last frame.

17-10 is an 8 bit self-increasing cyclic code, indicating the sequence number of the data, which ranges from 0 to 255.

CH15-CH0 indicates communication channel of node. The value ranges from 0 to 65535. When the value of the “Channel” is equal to 0, the data frame is the broadcast frame. All nodes may receive the broadcast frame.

The data field in the standard data frame and in the extended data frame is modified as Table B-1.

TABLE B-1
modification of definitions of data field of CAN 2.0B protocol data frame

| | | Original data field definition | | | | | | | |
|---|---|---|---|---|---|---|---|---|---|
| | | D0 | D1 | D2 | D3 | D4 | D5 | D6 | D7 |
| New | Node control | CMD | D0 | D1 | D2 | D3 | D4 | D5 | D6 |
| data field | instruction frame | | | | | | | | |
| definition | Node return | CMD | D0 | D1 | D2 | D3 | D4 | D5 | D6 |
| | instruction frame | | | | | | | | |
| | Uploading node | D0 | D1 | D2 | D3 | D4 | D5 | D6 | D7 |
| | serial code frame | | | | | | | | |
| | Configuring frame | D0 | D1 | D2 | D3 | D4 | D5 | D6 | D7 |
| | of channels | | | | | | | | |
| | Block control | CMD | D0 | D1 | D2 | D3 | D4 | D5 | D6 |
| | instruction frame | | | | | | | | |
| | Block return | CMD | D0 | D1 | D2 | D3 | D4 | D5 | D6 |
| | instruction frame | | | | | | | | |
| | Output frame of | D0 | D1 | D2 | D3 | D4 | D5 | D6 | D7 |
| | block data | | | | | | | | |
| | Input frame of block | D0 | D1 | D2 | D3 | D4 | D5 | D6 | D7 |
| | data | | | | | | | | |

Wherein the CMD relates to secondary instruction. Nodes may conduct their own instruction set, see Table B-2.

D0-D6 relate to data earned by secondary instruction.

D0-D7 relate to data carried by each frame during data transmission. The 8 bits are configured to enhance transmission efficiency.

TABLE B-2
A portion of CMD instructions

| CMD | Instruction message | Descriptions |
|---|---|---|
| FE | Instructions requesting | Main controller requests uploading node |
| | attributes | attributes |
| FD | Replying attributes | Acknowledge upload of node attributes to main |
| | | controller |
| FC | Requesting for deleting | Main controller requests node to delete the |
| | upgraded data area | upgraded data area |
| FB | Replying to request of | Acknowledge deletion of upgraded data area |
| | deleting upgraded data area | |
| FA | Instructions for requesting | Main controller requests node to transmit |
| | transmission of upgraded | upgraded data, and main controller downloads |
| | data | a volume of upgraded data |
| F9 | Replying to request of | Reporting status of receiving upgraded data |
| | transmission of upgraded | area to the main controller. Volume of |
| | data | upgraded data area will be reported when |
| | | upgraded data area has been received. |
| F8 | Sending instruction | Main controller notifies node that upgraded |
| | indicating that upgraded | data transmission is finished. |
| | data is finished | |
| F7 | Sending reply of upgraded | Confirming with main controller about whether |
| | data area transmission | upgraded data area has been received correctly. |
| | finished | |
| F6 | Abnormal reception of data | Main controller notifies node that there is data |
| | block | block lost |
| F5 | Abnormal reception of data | Node reports to main controller that there is |
| | block | data block lost. |
| F4 | Instructions requesting node | Main controller requests node to receive |
| | to receive parameters | subsequent data block including parameters. |
| F3 | Replying to request of | Confirming with main controller that node is |
| | parameter reception | ready to receive parameters. |
| F2 | Instructions requesting node | Main controller requests node to store |
| | to store parameters | parameters, received by buffer, to a parameter |
| | | table. |
| F1 | Replying status of parameter | Node reports to main controller about status of |
| | | storing parameter. |
| F0 | Instructions requesting the | Main controller requests node to reset |
| | node reset the parameters | parameters to factory default. |
| EF | Replying status of parameter | Node reports to main controller whether |
| | reset | parameters are reset to factory default. |
| EE | Requesting node reset | Main controller requests node reset. |
| ED | Replying to node reset | Confirming with main controller about node |
| | | reset. |
| EC | Requesting node to report | Querying node status. |
| | status | |
| EB | Reporting node status | Reporting node status |

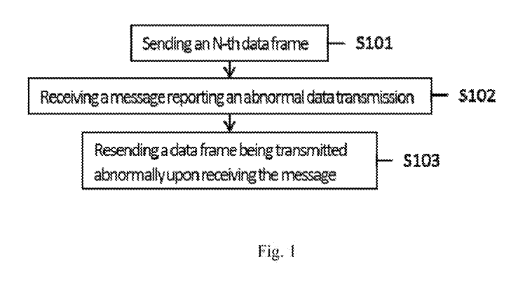

FIG. 1 is a flowchart illustrating a method for transmitting data through system bus in accordance with one embodiment of the present disclosure.

As shown in FIG. 1, the method includes step S101: sending an N-th data frame; step S102: receiving a message reporting an abnormal data transmission; step S103: resending a data frame being transmitted abnormally upon detecting receiving the message.

Alternatively, in step S101, the sending terminal sends the N-th data frame to the receiving terminal via one data transmission or a plurality of data transmission, wherein N is a positive integer. If the total number of data frames is M, M is a positive integer equal, to or less than 256, the sending terminal resends the N-th data frame to the receiving terminal repeatedly when the sequence number of the sent data frame, N, is a preset number between one to M, or N is equal to or greater than M/2. Besides, when the last data frame, i.e., the M-th data frame (N=M), is transmitted, the M-th data frame is also resent to the receiving terminal repeatedly.

Alternatively, the sending terminal may conduct the resending process when transmitting any data frames. The receiving terminal sends the message of the abnormal data transmission to the sending terminal upon receiving a duplicate data frame.

In step S102, when the receiving terminal re-receives the N-th data frame, the receiving terminal sends the message of the abnormal data transmission to the sending terminal. The message of the abnormal data transmission includes the number of the abnormally transmitted data frames and the sequence number of the abnormally transmitted data frames in the data transmission.

The block abnormal instruction indicating the main controller abnormal block transmission of the main controller are shown as Table 1.

TABLE 1

| | | The value | |
|---|---|---|---|
| Bit | Description | range | Function |
| 0 | CMD instruction | 0XF6 | Main controller notifies node of data |
| | | | lost |
| 1 | Number of abnormal data | 0-6 | Absolute value indicates number of |
| | frame transmitted | | block data that have not been received |
| 2-7 | Sequence number of | 0-255 | Index set of block data that have not |
| | abnormal data frame | | been received |
| | transmitted | | |

Block abnormal instruction indicating abnormal block transmission of node are shown as Table 2.

TABLE 2

| | | The value | |
|---|---|---|---|
| Bit | Description | range | Function |
| 0 | CMD instruction | 0XF5 | Node reports to main controller that |
| | | | there are data lost |
| 1 | Number of abnormal data | 0-6 | Absolute value indicates number of |
| | frame transmitted | | block data that have not been received |
| 2-7 | Sequence number of | 0-255 | Index set of block data that have not |
| | abnormal data frame | | been received |
| | transmitted | | |

The usage of the block abnormal instruction, such as 0XF6 (for main controller) and 0XF5 (for the nodes) are the same. The difference resides in the transmitting directions between main controller and node.

Therefore, abnormal, message of data transmission is carried by abnormal block instructions of main controller and nodes.

In step S103, resending the data frames being transmitted abnormally upon receiving the message.

The sending terminal analyzes instruction sent by the receiving terminal, determines the number of the abnormally transmitted data frames and the sequence number of the abnormally transmitted data frames in the data transmission, and resends the corresponding data frames according to the sequence number of the abnormally transmitted data frames.

In this embodiment, the method for transmitting data through system bus can complete the data transmission according to the protocol, and may resend the data frames being transmitted abnormally upon detecting the abnormal data transmission, as so to insure the integrity and the accuracy of the data transmission.

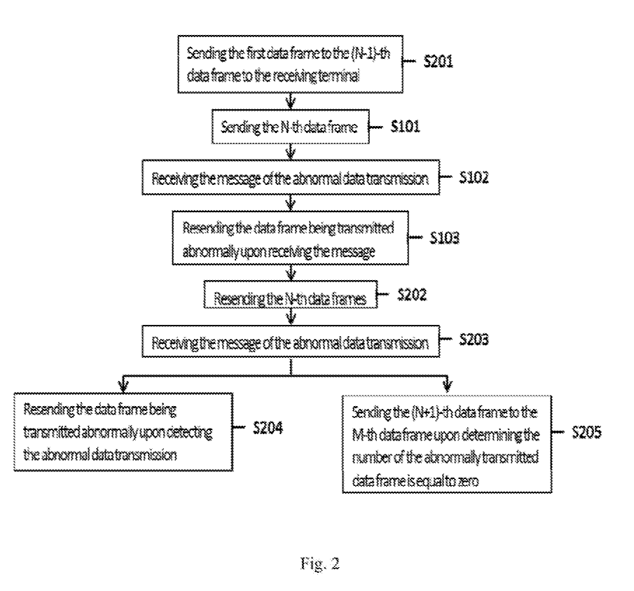

FIG. 2 is a flowchart illustrating a method for transmitting data through system bus in accordance with another embodiment of the present disclosure.

For sake of convenience of description, the same configuration between the previous embodiment and this embodiment is no longer detailed described, but focuses only on the difference between, the previous embodiment and the embodiment. In FIG. 2, the step which is the same as or similar to the previous embodiment use the same reference numerals.

As shown in FIG. 2, the method further includes step S201: sending the first data frame to the (N−1)-th data frame to the receiving terminal; step S202: resending the N-th data frame; and step S203: receiving the message of the abnormal data transmission.

Alternatively, before the sending terminal sends the N-th data frame, the sending terminal sequentially sends the first to (N−1)-th data frames to the receiving terminal for one time. The total number of the data frames being transmitted is M, wherein M is the positive integer. When M is equal to or less than 256, the sending terminal resends the N-th data frame to the receiving terminal, and the index, of the N-th data frame is N−1, wherein N is the positive integer and is a preset number between one to M, or N is equal to or greater than M/2. In addition, with respect to the last transmitted data frame, i.e., the M-th data, frame, the sending terminal resends the M-th data frame to the receiving terminal repeatedly, and the index equals to M−1. In step S102, when the receiving terminal receives the data frames having the same index, the receiving terminal sends the message of the abnormal data transmission to the sending terminal. In step S103, if the number of the abnormally transmitted data frame is not equal to 0, the sending terminal may resend the corresponding data frames to the receiving terminal according to the sequence numbers of the abnormally transmitted data frames. In step S202, after the sending terminal resends the data frames being transmitted abnormally, the sending terminal resends the data frame having the index equaling to “N−1” to the receiving terminal to detect the abnormal data transmission. In step S203, the sending terminal receives the message of the abnormal data transmission from the receiving terminal. In step S204, the sending terminal resends the data frame being transmitted abnormally upon detecting the abnormal data transmission, that is, when the number of the abnormally transmitted data frame is not equal to 0. In step S205, the sending terminal continues to sequentially send the (N+1)-th data frame to the (M−1)-th data frame to the receiving terminal upon determining the number of the abnormally transmitted data frame is equal to zero, wherein M is the positive integer and is greater than N+1. Alternatively, the M-th data frame is the last data frame being sent to the data transmission. It is determined that the data transmission is completed when N=M.

In one embodiment, step S202 can be omitted. That is, after the sending terminal resends the data frames being transmitted abnormally, the data, frame having the index equal to “N−1” may not be resent by the sending terminal. After the receiving terminal receives the duplicate data frame being transmitted abnormally, the receiving terminal directly sends the message of the abnormal data transmission to the sending terminal.

In one scenario, the main controller of a robot may upgrade the data on the node 10. The size of the data sector being upgraded is 2K, and the volume of the data being upgraded is 7K. The CMD instructions relating to the operations are shown as Table B-2.

In the scenario, the data block is the data frame, the main controller is the sending terminal, and the node 10 is the receiving terminal.

The main controller sends an upgrading data request to the node 10. The corresponding fields in the upgrading data request are set as: MIM0E-100, channel=10, and CMD=0XFC.

The node 10 sends the upgrading data response to the main controller. The corresponding fields in the message are set as: MIM0EM0=110, channel=10, CMD=0XFB, and D1-D4=7K.

The main controller sequentially sends the first data frame to the (N−1)-th data frame to the node 10 for one time. The process is:

The main controller sends the first data frame to the node 10. The corresponding fields are: MIM0EM0=101, channel=10, END=0, index=0, and D0-D7 indicates the first 8 bits of the upgraded data.

The main controller sends the second data frame to the node 10. The corresponding fields are: MIM0EM0=101, channel=10, END=0, index=1, and D0-D7 indicates the second 8 bits of the upgraded data.

The main controller sends the N-th data frame to the nodes 10. The corresponding fields are: MIM0EM0=101, channel=10, END=0, index=N−1, and D0-D7 indicates the N-th 8 bits of the upgraded data.

The main controller sends the 128-th data frame to the nodes 10 (the index of the data frame is 127). At this moment, the main controller resends the data frame having index equal to 127. The index has not been increased at this time.

The nodes 10 receive the duplicate data frame having the index equal to 127, and then sends the message of the abnormal data transmission.

If five data frames, having the indexes equal to 5, 7, 15, 20 and 29, have not been received by the receiving node or if an error has been occurred daring the data transmission on these data frames, the node 10 sends the message of the abnormal date transmission to the main controller. The corresponding fields are: MIM0EM0=110, channel=10, CMD-0XF5, D0=5, D1−D5=5, 7, 15, 20, and 29. In the message, the bit D0 indicates the number of the abnormally transmitted data frames during the data transmission, and the bits D1-D6 indicate the sequence number of the abnormally transmitted data frames during the data transmission. The main controller receives: the message of the abnormal data transmission from the node 10, and then analyzes and determines whether the value of D0 is greater than zero or not if the value of D0 is greater than zero, it is determined that the data transmission is abnormal. The five data frames having the indexes equal to 5,7 15, 20, and 29 are resent to the node 10 according to the sequence number of the D1-D6 presented.

After the main controller resends the five data frames, the main controller resends the data frame having the index equal to 127 to the node 10.

The node 10 receives the duplicate data frame having the index equal to 127, and then sends the message of the abnormal data transmission.

If all of the five data frames having the indexes equal to 5, 7, 15, 20, and 29 are received correctly by the node 10, the node 10 sends the message of the abnormal data transmission to the main controller. The corresponding fields are: MIM0EM0=110, channel=10, CMD=0XF5, and D0=0.

The main controller receives the message of the abnormal data transmission, analyzes the message of the abnormal data transmission, and determines that the number of the abnormally transmitted data frames is equal to 0. That is, no abnormal date frame has been transmitted during the data transmission. Afterward, the main controller continues sequentially sending the rest of the data, frames when N is not greater then M.

The method for the main controller to send the data frames having the indexes from 128 to 254, that is the 129^{th} to 255^{th} data frames, is the same as the method to send the data frames having indexes from 0 to 126. The description is omitted here.

When the main controller transmits the last data frame, the main controller resends the data frame having the index equal to 255 repeatedly. The corresponding fields are: MIM0EM0=110, channel=10, END=1, index=255, and D0-D7.

When the node 10 receives the duplicate data frame having the index equal to 255, the node 10 then sends the message of the abnormal data transmission.

After the main controller receives the message of the abnormal data transmission, it is determined that the data has been upgraded when the number of the abnormally transmitted data frame is equal, to zero; otherwise, the corresponding data frames, are resent according to the sequence number indicated in D1-D6.

The main controller notifies the node 10 that the data has been ungraded, the corresponding fields are MIM0EM0=100, channel=10, CMD=0XF8, D1-D4=2K, D5=1, D6=2, wherein D5=1 presents writing upgrade data, and D6=2 presents restarting and entering boot system, to upgrade data 2 seconds later.

The node 10 confirms with the main controller 10 that the data has been upgraded, and the corresponding fields are: MIM0EM0=110, channel=10, CMD=0XF7, D1-D4=2K, D5=1, D6=2, wherein D5=1 presents write upgraded indication and D6=2 presents restarting and entering boot system to upgrade data 2 seconds later.

In the embodiment, the method for transmitting data through system bus can complete the data transmission according to protocol, and can resend the same data frame repeatedly when the number of the sent data frames is greater than half of the total numbers of the data frames and when the last data has been transmitted, so as to detect an abnormal data frame during the data transmission, and resends the data frames being transmitted abnormally upon detecting the abnormal data transmission, therefore easing the data transmission pressure of the system, and increasing the integrity and accuracy of the data transmission.

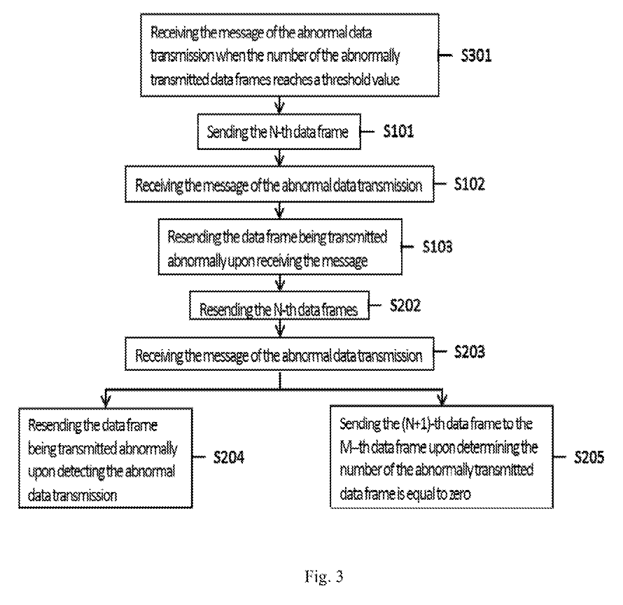

FIG. 3 is a flowchart illustrating a method for transmitting data through system bus in accordance with another embodiment of the present disclosure.

For sake of convenience of description, the same configuration, between the previous embodiment and this embodiment is no longer detailed described, but focuses only on the difference between the previous embodiment and the embodiment. In FIG. 3, the step which is the same as or similar to the previous embodiment use the same reference numerals.

Alternatively, in step S301, receiving the message of the abnormal data transmission when the number of the abnormally transmitted data frames reaches a threshold value.

The sending terminal starts sequentially sending the data frames to the receiving terminal from the first data fame for one time. The receiving terminal calculates the number of the abnormally transmitted data frames during the data transmission. When the number of the abnormally transmitted data frames reaches the threshold value, the receiving terminal sends the message of the abnormal data transmission if a W-th data frame should be transmitted. The sending terminal receives the message of the abnormal data transmission, and stops sequentially sending data frames to the receiving terminal for one time, and resends the corresponding data frames to the receiving terminal according to the message of the abnormal data, transmission including the sequence number of the abnormally transmitted data frames in the data transmission.

After the sending terminal resends the corresponding data frames, the sending terminal resends the W-th data frame to the receiving terminal. The receiving terminal resends the message of the abnormal data transmission prior to the W-th data frame.

In another embodiment, after the sending terminal resends the corresponding data frames, the receiving terminal resends the message of the abnormal data transmission again prior to the W-the data frame.

When no abnormal data frame has been transmitted, that is, the number of the abnormal data frames included in the message of the abnormal data, transmission is equal to zero, the sending terminal continues sending the data frames to the receiving terminal.

In the embodiment, the method for transmitting data through system bus can complete the data transmission according to protocol, and resends the duplicate data frame when the number of the abnormally transmitted data frame received reaches the threshold value, when the number of the sent data frames is the preset number, when the number of the sent data frames is greater than half of the total number of the data frames and when die last data has been transmitted, so as to detect an abnormal data, transmission, and resends the data frames being transmitted abnormally upon detecting the abnormal data transmission, therefore easing the data transmission pressure of the system, and increasing the integrity and accuracy of the data transmission.

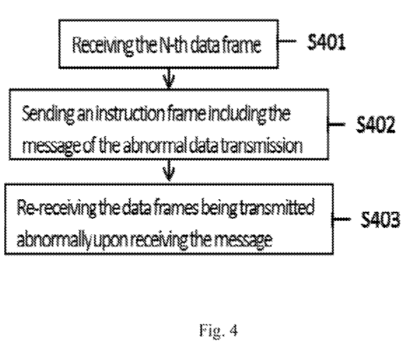

FIG. 4 is a flowchart illustrating a method for transmitting data through system bus in accordance with another embodiment of the present disclosure.

As shown in FIG. 4, the method includes step S401: receiving the N-th data frame; step S402: sending an instruction frame including the message of the abnormal data transmission: step S403: re-receiving the data frames being transmitted abnormally upon detecting the abnormal data transmission.

Alternatively, in step S401, the receiving terminal receives the N-th data frame for one or more than one time. In step S402, the receiving terminal sends the instruction frame including the message of the abnormal data transmission to the sending terminal, wherein the message of the abnormal data transmission includes the number of the abnormally transmitted date frames and the sequence number of the abnormally transmitted data frames in the data transmission.

In the embodiment, when the receiving terminal receives the duplicate data frame, the receiving terminal sends the message of the abnormal data transmission including the number of the abnormally transmitted data frames and the sequence number of the abnormally transmitted data frames during the data transmission, prior to the duplicate data frame.

In step S403, re-receiving the data frames being transmitted abnormally upon receiving the message. If the number of the abnormally transmitted data frames is not equal to zero, the receiving terminal receives the data frames being transmitted abnormally from the sending terminal.

In this embodiment, the method for transmitting data through system bus can complete data transmission according to the protocol, and can resend the data frames being transmitted abnormally upon detecting the abnormal data transmission, as so to insure the integrity and the accuracy of the data transmission.

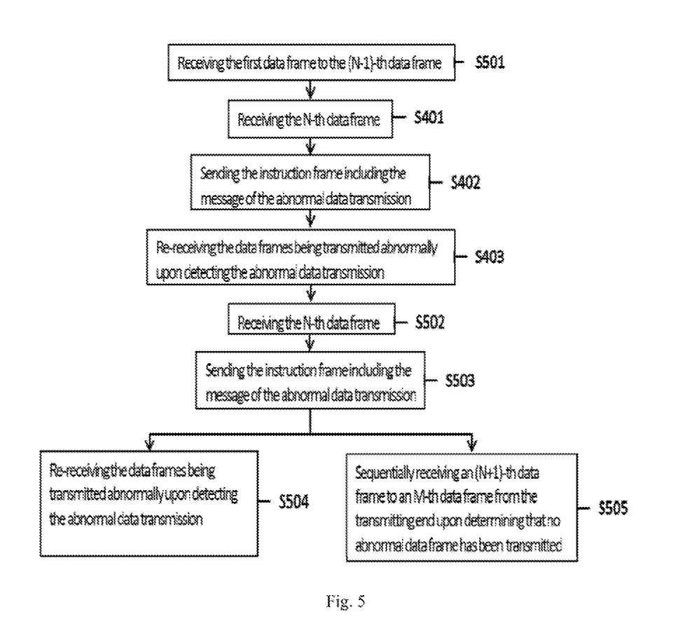

FIG. 5 is a flowchart illustrating a method for transmitting data through system bus in accordance with another embodiment of the present disclosure.

For sake of convenience of description, the same configuration between the previous embodiment and this embodiment is no longer detailed described, but focuses only on the difference between the previous embodiment and the embodiment. In FIG. 5, the step which is the same as or similar to the previous embodiment use the same reference numerals.

In FIG. 5, the method further includes step S501: receiving the first data frame to the (N−1)-th data frame sent by the sending terminal; step S502: receiving the N-th data, frame; step S503: sending an instruction frame including the message of the abnormal data transmission; step S504: re-receiving the data frames being transmitted abnormally upon detecting the abnormal transmission; and step S505: sequentially receiving an (N+1)-th data frame to an (M−1)-th data frame from the sending terminal for one time upon determining that no abnormal data frame has been transmitted.

In one embodiment, in step S501, the receiving terminal sequentially receives the first data frame to the (N−1)-th data frame from the sending terminal for one time. In step S401, the receiving terminal receives the N-th data frame sent by the sending terminal for one or more than one time. In step S402, the receiving terminal sends the instruction frame including the message of the abnormal data transmission to the sending terminal, wherein the message of the abnormal data transmission includes the number of the abnormally transmitted data frames and the sequence number of the abnormally transmitted data frames in the data transmission, in step S403, re-receiving the date frames being transmitted abnormally upon detecting the abnormal data transmission. In step S502, receiving the duplicate N-th data frame resent by the sending terminal. In step S503, the receiving terminal resends the message of the abnormal data transmission prior to the duplicate N-th data frame. In step S504, the receiving terminal re-receives the data frame being transmitted abnormally upon detecting the abnormal data transmission. In step S505 sequentially receiving an (N+1)-th data frame to an (M−1)-th data frame from, the sending terminal for one time upon determining that no abnormal data frame has been transmitted, wherein M is a positive integer and is greater than N+1.

In one embodiment, the step S502 can be omitted. The sending terminal resends the data frames being transmitted abnormally upon detecting the abnormal data transmission, and does not resend the N-th data frame. Therefore, the receiving terminal does not receive the duplicate N-th data frame resent by the sending terminal.

In the embodiment, the method for transmitting data through system bus can complete the data transmission according to protocol, and resends the duplicate data frame when the number of the sent data frames is greater than half of the total number of the data frames and when the last data has been transmitted, so as to detect the abnormal data transmission, and resends the data frames being transmitted abnormally upon detecting the abnormal data transmission, therefore easing the data transmission pressure of the system, and increasing the integrity and accuracy of the data transmission.

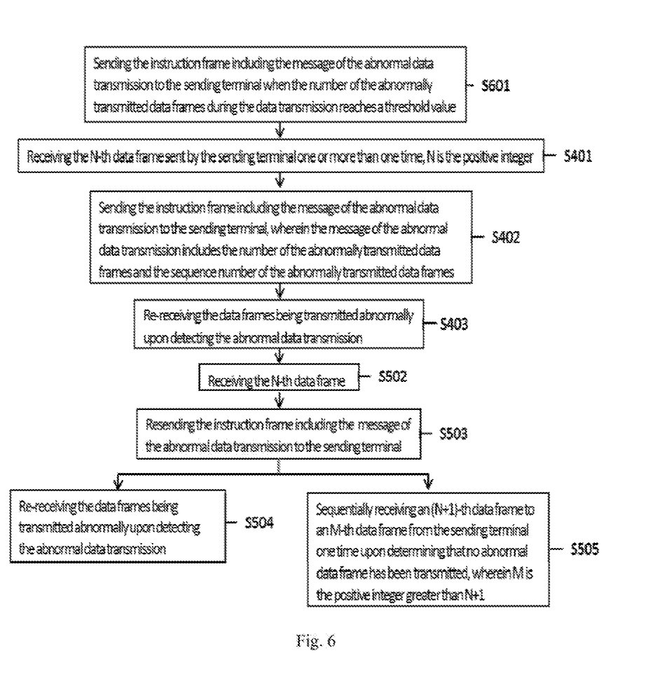

FIG. 6 is a flowchart illustrating a method for transmitting data through system bus in accordance with another embodiment of the present disclosure.

For sake of convenience of description, the same configuration between the previous embodiment and this embodiment is no longer detailed described, but focuses only on the difference between the previous embodiment and the embodiment. In FIG. 6, the step which is the same as or similar to the previous embodiment use the same reference: numerals.

Alternatively, in step S601, sending the instruction frame including the message of the abnormal data transmission to the sending terminal when the number of the abnormally transmitted data frames during the data transmission reaches a threshold value.

The receiving terminal calculates the number of the abnormality transmitted data frames during the data transmission. When the number the abnormally transmitted data frame received reaches the threshold value, the receiving terminal sends the instruction frame including the message of the abnormal data transmission to the sending terminal.

In the embodiment, the method for transmitting data through system bus can complete the data transmission according to protocol, and resends the duplicate data frame when the number of the abnormally transmitted data frame reaches the threshold value, when the number of the sent data frames is greater than half of the total number of data frames and when the last data has been, transmitted, so as to detect the abnormal data transmission, and resends the data frames being transmitted abnormally upon detecting the abnormal data transmission, therefore increasing the integrity and accuracy of the data transmission.

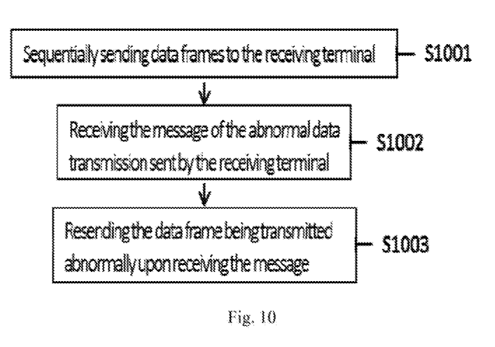

FIG. 10 is a flowchart illustrating a method for transmitting data through system bus in accordance with another embodiment of the present disclosure.

For sake of convenience of description, the same configuration between the previous embodiment and this embodiment is no longer detailed described, but focuses only on the difference between the previous embodiment and the embodiment.

In one embodiment, the data transmission method for system bus includes step S1001; sequentially sending data frames to the receiving terminal; step S1002; receiving the message of the abnormal data transmission sent by the receiving terminal; step S1003: resending the data frame being transmitted abnormally upon receiving the message. Wherein the message of the abnormal data transmission includes the number of the abnormally transmitted data frames and the sequence number of the abnormally transmitted data frames during the data transmission. It is convenient to check if an abnormally transmitted data frame exist or not by utilizing the number of the abnormally transmitted data frames, and check which data frames are transmitted abnormally by utilizing the sequence number of the abnormally transmitted data frames. Wherein the abnormally transmitted data frames include but not limit to the data frames being transmitted wrongly and the data frame being transmitted loss.

In the embodiment, the method for transmitting data through system bus can complete the data transmission according to protocol, and resends the data frames being transmitted abnormally upon detecting the abnormal data transmission, therefore increasing the integrity and accuracy of the data transmission.

In one embodiment, the method for transmitting data through system bus includes sequentially sending data frames to the receiving terminal, wherein the N-th data frame is sent to the receiving terminal one or more than one times, wherein N is the positive integer; receiving the message of the abnormal data transmission sent by the receiving terminal; resending the data frame being transmitted abnormally upon defecting the abnormal data transmission. Wherein the N-th date frame is the last data frame during this data transmission, or N is equal to or greater than M/2, M is the total number of the data frames during this data transmission.

It can be seen that by resending the duplicate N-th data frame to the receiving terminal for more than one time, first, it insures that the receiving terminal can receive the N-th data frame, and it will not lose the frame; furthermore, when the receiving terminal receives the duplicate N-th data frame, it starts to perform the abnormal transmission reply, and then sends the message of the abnormal data transmission to the sending terminal.

Besides, N is equal to or greater than M/2, so as to increase the reliability of system transmission and take care of the system, loading, and effectively shorten the time delay of the data transmission.

In one embodiment, after the step of resending the data frame being transmitted abnormally, the method further includes sending the N-th data frame to the receiving terminal for one or more than one times. The purpose is that not only remind the receiving terminal that the resenting process is completed but also notify the receiving terminal to perform the abnormal transmission reply again.

In one embodiment, the method for transmitting data through system bus includes: sequentially sending data frames to the sending terminal, wherein the first data frame to the (N−1)-th data frame are sequentially transmitted to the receiving terminal for one time, and the N-th data frame is transmitted to the receiving terminal for one or more than, one time receiving the message of the abnormal data transmission sent by the receiving terminal; resending the data frames being transmitted abnormally upon detecting the abnormal data transmission. Wherein the abnormally transmitted date frames are part or all of the data frames from the first data frame to the (N−1)-th data frame.

In one embodiment, the method for transmitting data through system bus includes: sequentially sending the data frames to the receiving terminal, wherein the first data frame to the (N−1)-th data frame are sent to the receiving terminal for one time, and the N-th data frame is sent to the receiving terminal for one or more than one time; receiving the message of the abnormal data transmission from the receiving terminal; resending the data frames being transmitted abnormally upon detecting the abnormal data transmission; sequentially sending the (N+1)-th data frame to the remaindering data frame upon determining no abnormal data frame has been transmitted.

In another embodiment, the method for transmitting data through system bus includes: sequentially receiving the data frames sent by the sending terminal; sending the message of the abnormal data transmission to the sending terminal; and re-receiving the data frames being transmitted abnormally upon detecting the abnormal data transmission.

In another embodiment, the method for transmitting data through system bus includes: sequentially receiving the data frames sent by the sending terminal, wherein the N-th data frame sent by the sending terminal is received one or more than one time, wherein N is the positive integer; sending the message of the abnormal data transmission to the receiving terminal; re-receiving the data frames being transmitted abnormally upon detecting the abnormal data transmission. Wherein the N-th data frame is the last data frame in the transmission, or N is equal to or greater than M/2, M is the total number of the data frame in the data transmission.

It can be seen that by utilizing receiving the duplicate N-th data frame to the receiving terminal for more than one time, it insures that the receiving terminal can receive the N-th data frame, and it will not loss the frame, and when the receiving terminal receives the duplicate N-th data frame, it starts to perform the instruction of the abnormal transmission reply, and notify that the receiving terminal sends the message of the abnormal data transmission to the sending terminal.

In one embodiment, after the step of re-receiving the data frames being transmitted abnormally, the method further includes: receiving the N-th data fame sent by the sending terminal for one or more than one time. The purpose is that it can be determined that the resenting process is completed and to perform the abnormal transmission reply again.

In one embodiment, the method for transmitting data through system bus includes: sequentially receiving the data frames sent by the sending terminal, wherein the first data frame to the (N−1)-th data frame are sequentially received, and the N-th data frame is received, N is the positive integer; sending the message of the abnormal data transmission to the sending terminal: re-receiving the data frames being transmitted abnormally upon detecting the abnormal data transmission. Wherein the abnormally transmitted data frames are part or all of the data frames from the first data frame to the (N−1)-th data frame.

In one embodiment, the method for transmitting data through system bus includes: sequentially receiving the data frames sent by the sending terminal, wherein the first data frame to the (N−1)-th data frame are sequentially received, and the N-th data frame is received, wherein N is the positive integer; sending the message of the abnormal data transmission to the sending terminal; re-receiving the data, frame being transmitted abnormally upon detecting the abnormal data transmission; sequentially receiving the (N+1)-th data frame to the remaindering data frames one time upon determining no abnormally transmitted data frame has been transmitted.

In one embodiment, the method (or transmitting data through system bus: sequentially receiving data frames from the sending terminal, and calculating the number of the abnormally transmitted data, frame during the data transmission; sending the message of the abnormal data transmission to the sending terminal when the number of the abnormally transmitted data frames reaches the threshold value; re-receiving the data frames being transmitted abnormally upon detecting the abnormal data transmission.

In one embodiment, the method for transmitting data through system bus includes: sequentially receiving the data frames sent by the sending terminal and calculating the number of the abnormally transmitted data frames during the data transmission; sending the message of the abnormal data transmission to the sending terminal when the number of the abnormally transmitted data frames during the data transmission reaches the threshold value or when the N-th data frame is received from the sending terminal more than one time; re-receiving the data frame being transmitted abnormally upon detecting the abnormal data transmission. Wherein N is the positive integer.

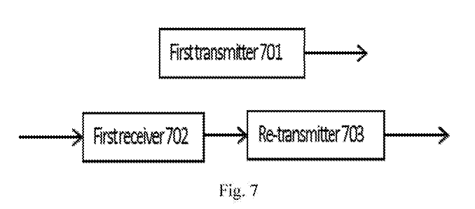

FIG. 7 is a schematic view of a device for transmitting data through system bus in accordance with one embodiment of the present disclosure.

In the embodiment, the device includes a first transmitter 701, a first receiver 702, and a re-transmitter 703.

The first transmitter 701 is configured to send the N-th data frame to the receiving terminal for one or more than one time, wherein N is the positive integer.

The first receiver 702 is configured to receive the message of the abnormal data transmission sent by the receiving terminal, the message of the abnormal data transmission including the number of the abnormally transmitted data frames and the sequence number of the abnormally transmitted data frames during the data transmission.

The re-transmitter 703 is configured to resend the data frames being transmitted abnormally upon detecting upon receiving the message.

The first transmitter 701 is further configured to sequentially send a first data frame to a (N−1)-th data frame to the receiving terminal before sending the N-th data frame to the receiving terminal for one or more than one time.

The first transmitter 701 is further configured to resend the duplicate N-th data frame to the receiving terminal before the first receiver 702 re-receives the message of the abnormal data transmission sent by the receiving terminal.

The first receiver 702 is further configured to re-receive the message of the abnormal data transmission sent by the receiving terminal.

The re-transmitter 703 is further configured to resend the data frame being transmitted abnormally upon receiving the message.

The first transmitter 701 is further configured to continue sequentially sending the (N+1)-th data frame to the (M−1)-th data frame to the receiving terminal, wherein, y is the positive integer and is greater than N+1.

The device for transmitting data through system bus in the embodiment can use the above method to control the data transmission for buses and on-line upgraded data of the nodes.

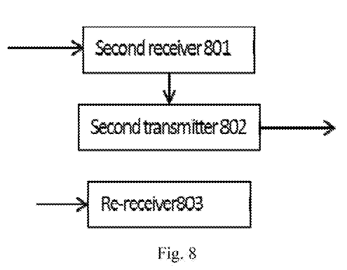

FIG. 8 is a schematic view of a device for transmitting data through system bus in accordance with another embodiment of the present disclosure.

In the embodiment, the device includes a second receiver 801, a second transmitter 802, and a re-receiver 803.

The second receiver 801 is configured to receive an N-th data frame sent by the sending terminal one or more than one time, wherein N is the positive integer.

The second transmitter 802 is configured to send the instruction frame including the message of the abnormal data transmission to the sending terminal, wherein the message of the abnormal data, transmission includes the number of the abnormally transmitted data frames and the sequence number of the abnormally transmitted data frames during the data transmission.

The re-receiver 803 is configured to re-receive the data frame being transmitted abnormally upon detecting the abnormal data transmission,

The second transmitter 802 is further con figured to resend the instruction frame including the message of the abnormal data transmission after the re-receiver 803 re-receives the data frame being transmitted abnormally.

The second receiver 801 is further configured to sequentially receive a first data frame to an (N−1)-th data frame sent by the sending terminal before receiving the duplicate N-th data frame from the sending terminal

The second receiver 801 is further configured to re-receive the duplicate N-th data frame sent by the sending terminal.

The second transmitter 802 is further configured to resend the instruction frame including the message of the abnormal data transmission to the sending terminal.

The re-receiver 803 is further configured to re-receive the data frame being transmitted abnormally upon detecting the abnormal data transmission.

The second receiver 801 is further configured to continue sequentially receiving an (N+1)-th data frame to the (M−1)-th data frame from the sending terminal one time, wherein M is a positive integer and is greater than N+1.

The device for transmitting data through system bus in the embodiment can use the above method to control the data transmission for buses and on-line upgraded data of the nodes.

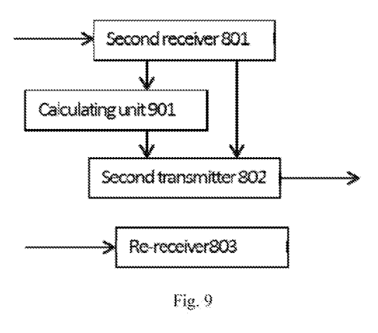

FIG. 9 is a schematic view of a device for transmitting data through system bus in accordance with another embodiment of the present disclosure.

For sake of convenience of description, the same configuration between the previous embodiment, and this embodiment is no longer detailed described, but focuses only on the difference between the previous embodiment and the embodiment. In FIG. 9, the step which is the same as or similar to the previous embodiment use the same reference numerals.

In the embodiment, the device includes a second receiver 801, a second transmitter 802, a re-receiver 803, and a calculating unit 901.

The calculating unit 901 is configured to calculate the number of the abnormally transmitted data frames, during the data transmission. When the number of the abnormal data frames reaches the threshold value, the second transmitter 802 sends the instruction frame including the message of the abnormal data transmission to the sending terminal.

The device for transmitting data through system bus in the embodiment can use the above method to control the data transmission for buses and on-line upgraded data of the nodes.

Alternatively, the device for transmitting data through system bus includes a first transmitter configured to sequentially send the data frames; a first receiver configured to receive the message of the abnormal data transmission; and a re-transmitter configured to resend the data frame being transmitted abnormally. Alternatively, the first receiver receives the message of the abnormal data transmission after the first transmitter sends the N-th data frame for one or more than one time, wherein N is a positive integer. The N-th data frame is the last data frame in this data transmission; or N is equal to or greater than M/2, wherein M is the number of the data frame in the data transmission. Alternatively, the first transmitter sends the N-th date frames for one or more than one time alter the re-transmitter resends the data frames being transmitted abnormally. Alternatively, the first transmitter sequentially sends the first data frame to the (N−1)-th data frame one time. Alternatively, the first transmitter sequentially sends the (N+1)-th data frame to the remaindering data frames for one time.

Alternatively, the device for transmitting data through system bus includes a second receiver configured to sequentially receive the data frames; a second transmitter configured to send the message of the abnormal data transmission; and a re-receiver configured to re-receive the data frame being transmitted abnormally, wherein the second transmitter sends the message of the abnormal data transmission when the number calculated by the calculating unit reaches the threshold value.

Alternatively, the device for transmitting data through system bus includes a second receiver configured to sequentially receive data frames; a second transmitter configured to send the message of the abnormal data transmission; a re-receiver configured to re-receive the data frames being transmitted abnormally; and a calculating unit configured to calculate the number of the abnormally transmitted data frame during the data transmission, wherein the second transmitter sends the message of the abnormal data transmission when the number calculated by the calculating unit reaches the threshold or after the second receiver receives the N-th data frame one or more than one time, wherein N is a positive integer.

The effect of the device for transmitting data through system bus in the embodiments is described as above, and not described here.

In an example, the present disclosure further provides non-transitory computer readable medium, for example, memory including the instructions that can be executed by the processor to utilize the above method. The non-transitory computer readable medium may be a read only memory (ROM), a random access memory (RAM), magnetic tapes or optical data storage devices.

A person skilled in the art should understand that the disclosed combinations of various exemplary logical blocks, modules, circuits, and algorithm steps described in the present disclosure may be implemented as electronic hardware, computer software or a combination of both. In-order to clearly describe such interchangeability of the hardware and software, functions of the various exemplary components, blocks, modules, circuits, and algorithm steps have been generally described thereof. Whether such functions are implemented as software or hardware depends on the specific application and the design restrictions applied to the entire system. A person skilled in the art may implement the above described functions in various manners in combination with the specific applications. However, such implementation decisions shall not be construed as causing a departure from the scope of the present disclosure.

While the foregoing disclosure illustrates exemplary embodiments of the present disclosure, it should be noted that without departing from the scope defined by the claims of the disclosed premise, various modifications and changes can be made. A method according to an embodiment of the disclosure described herein required functions, steps and/or actions need not be performed in any particular order. In addition, although elements of the present disclosure may he described or claimed in the individual form, but they can also he envisaged more unless explicitly restricted to the singular.

The above description is merely the embodiments in the present disclosure, the claim, is not limited to the description thereby. The equivalent structure or changing of the process of the content of the description and the figures, or to implement to other technical field directly or indirectly should be included in the claim.

What is claimed is:

1. A method, for transmitting data, through system bus between a main controller and a node of a robot, the method comprising:
sequentially sending N number of data frames to the node, wherein N is a positive integer, and a total number of the data frames to be sent is equal to M, M is the positive integer;
resending the N-th data frame to the node repeatedly when N is a positive integer between one to M;
receiving, from the node, a message reporting an abnormal data transmission upon resending the resent N-th data frame; and
resending the data frames being transmitted abnormally upon receiving the message.

2. The method as claimed in claim 1, wherein before the step of sequentially sending N number of data frames to the node, the method further comprises encapsulating a data package to be sent into M number of the data frames.

3. The method as claimed in claim 2, wherein the method further comprises: resending the N-th data frame to the node when N is equal to M.

4. The method as claimed hi claim 3, wherein the message of the abnormal data transmission comprises the number of abnormally transmitted data frames and the sequence number of the abnormally transmitted data frames.

5. The method as claimed in claim 4, wherein the resending step further comprises: resending the corresponding data frames upon determining the number of the abnormally transmitted data frames is greater than zero;
sending the data frames until N equals to M upon determining the number of the abnormally transmitted data frames equals to zero.

6. The method as claimed in claim 3, wherein, before the sending step, the method further comprises:
sending an upgrading data request from the main controller, and the upgrading data request is a secondary instruction encoded in a standard data frame or an extended data frame being transmitted on a controller area network (CAN) bus.

7. The method as claimed in claim 2, wherein the method farther comprises: resending the N-th data frame to the node when N equals to or greater than M/2.

8. A method for transmitting data through system bus between a main controller and a node of a robot, the method comprising:
sequentially receiving N number of data frames sent by the main controller, wherein N is a positive integer, and a total number of the data frames is equal to M, M is the positive integer;
receiving the duplicate N-th data frame sent by the sending terminal when N is a positive integer between one to M;
sending a message reporting an abnormal data transmission to the main controller upon receiving the duplicate N-th data frame; and
re-receiving the data frame being transmitted abnormally upon detecting the abnormal data transmission.

9. The method as claimed in claim 8, wherein the method further comprises: receiving the duplicate N-th data frame sent by the sending terminal when N is equal to M.

10. The method as claimed in claim 9, wherein the message of the abnormal data transmission comprises the number of abnormally transmitted data frames and the sequence number of the abnormally transmitted data frames.

11. The method as claimed in claim 10, wherein the re-receiving step further comprises: re-receiving the corresponding data frames upon determining the number of abnormally transmitted data frames is greater than zero;
receiving the data frames until N equals to M upon determining the number of abnormally transmitted data frames equals to zero.

12. The method as claimed in claim 9, wherein, before the receiving step, the method further comprises;
receiving an upgrading data request from the main controller, and the upgrading data request is a secondary instruction encoded in a standard data frame or an extended data frame being transmitted on a controller area network (CAN) bus.

13. The method as claimed in claim 12, further comprising calculating a number of the abnormally transmitted data frames.

14. The method as claimed in claim 8, wherein the method further comprises:
receiving the duplicate N-th data frame sent by the sending terminal when N equals to or greater than M/2.

15. A device for transmitting data through system bus, the device comprising:
one or more processors; and
a memory; and
one or more programs;
wherein, the one or more programs are stored in the memory and configured to be executed by the one or more processors, the one or more programs comprise: instructions for sequentially sending N number of data frames to a node of a robot, wherein N is a positive integer, and a total number of the data frames to be sent is equal to M, M is the positive integer, instructions for resending the N-th data frame to the node repeatedly when N is equal to or greater than a preset number between one to M; instructions for receiving a message reporting an abnormal data transmission upon resending the resent N-th data frame; and instructions for resending data frame being transmitted abnormally upon receiving the message.

16. The device as claimed in claim 15, wherein the one or more programs further comprise: instructions for resending the N-th data frame when N is equal to M.

17. The device as claimed in claim 16, wherein the message of the abnormal data transmission comprises the number of abnormally transmitted data frames and the sequence number of the-abnormally transmitted data frames.

18. The device as claimed in claim 17, wherein the one or more programs further comprise: instructions for resending the corresponding data frames upon determining the number of the abnormally transmitted data frames is greater than zero; and instructions for sending the data frames until N equals to M upon determining the number of the abnormally transmitted data frames is equal to zero.

19. The device as claimed in claim 16, wherein the one or more programs further comprise: instructions for sending an upgrading data request from a main controller of a robot, and the upgrading data request is a secondary instruction encoded in a standard data frame or an extended data frame being transmitted on a controller area network (CAN) bus before sending sequentially send N number of data frames.

20. The device as claimed in claim 15, wherein the one or more programs further comprise: instructions for resending the N-th data frame when N is equal to or greater than M/2.
